(19) United States
(12) Patent Application Publication
(10) Pub. No.: US 2015/0207351 A1
(43) Pub. Date: Jul. 23, 2015

(54) MOBILE CHARGING DEVICE FOR A MOBILE DEVICE

(71) Applicants: William Hamburgen, Palo Alto, CA (US); Kevin Tom, San Francisco, CA (US)

(72) Inventors: William Hamburgen, Palo Alto, CA (US); Kevin Tom, San Francisco, CA (US)

(73) Assignee: GOOGLE INC., Mountain View, CA (US)

(21) Appl. No.: 13/544,508

(22) Filed: Jul. 9, 2012

(51) Int. Cl. H02J 7/00

(52) U.S. Cl. CPC H02J 7/0044

(57) ABSTRACT

A mobile charging apparatus for a mobile device includes a mobile sleeve capable of receiving and storing a mobile device. The mobile sleeve includes a first connector to mate with a charging port on the mobile device. The mobile charging apparatus includes a mobile energy source contained within the mobile sleeve to provide a charge to the mobile device through the first connector.

### TECHNICAL FIELD

This description relates to a mobile charging device for a mobile device.

### BACKGROUND

Electronic devices, including mobile electronic devices such as laptop computers, tablet computers, electronic reading devices and mobile phones, are increasing in numbers in the market and increasing in use by the public. One consideration for electronic devices is the constant need to recharge the energy source (e.g., the batteries) using a charger that has to be plugged into a fixed source (e.g., a wall receptacle). It is desirable to have other options for charging the energy source of the electronic devices.

### SUMMARY

According to one general aspect, a mobile charging apparatus for a mobile device includes a mobile sleeve capable of receiving and storing a mobile device. The mobile sleeve includes a first connector to mate with a charging port on the mobile device. The mobile charging apparatus includes a mobile energy source contained within the mobile sleeve to provide a charge to the mobile device through the first connector.

Implementations may include one or more of the following features. For example, the energy source may include one or more batteries. The first connector may include a cord reel and cord and may be configured to extend the first connector outside of the mobile sleeve. The first connector may include a retractable cord reel and cord. The first connector may include a detachable cord reel and cord. The first connector may be configured to connect to an external energy source to charge the energy source contained within the mobile sleeve. The mobile charging apparatus may include a second connector configured to mate with an external energy source to charge the energy source contained within the mobile sleeve. The mobile sleeve may include a bag capable of receiving and storing the mobile device and the bag may include the first connector to mate with the charging port on the mobile device and the energy source may be contained within the bag to provide the charge to the mobile device through the first connector. The mobile sleeve may include a device to capture solar energy and the energy source may be configured to store the solar energy and to provide the charge to the mobile device through the first connector using the stored solar energy. The energy source may include a fuel cell.

In another general aspect, a mobile charging apparatus includes a mobile sleeve capable of receiving and storing a mobile device. The mobile sleeve includes an energy source, a first connector configured to mate with a charging port on the mobile device to charge the mobile device from the energy source and a retractable cord reel and cord configured to extend the first connector external to the mobile sleeve.

Implementations may include one or more of the following features. For example, the mobile sleeve may include a bag. The energy source may include one or more batteries. The first connector may be configured to connect to an external energy source to charge the energy source in the mobile sleeve. The mobile sleeve may include one or more devices to capture solar energy and the energy source may be configured to store the solar energy and to provide the charge to the mobile device through the first connector using the stored solar energy. The mobile sleeve may include a second connector configured to mate with an external energy source to charge the energy source in the mobile sleeve. The retractable cord reel and cord may be detachable from the mobile sleeve.

In another general aspect, a mobile charging apparatus for a mobile device includes a mobile sleeve capable of receiving and storing a mobile device. The mobile sleeve includes a wireless charging interface capable of transferring charge to the mobile device and a mobile energy source contained within the mobile sleeve to provide a charge to the mobile device through the wireless charging interface.

Implementations may include one or more of the following features. For example the mobile sleeve may include a bag. The energy source may include one or more batteries.

The details of one or more implementations are set forth in the accompanying drawings and the description below. Other features will be apparent from the description and drawings, and from the claims.

### BRIEF DESCRIPTION OF THE DRAWINGS

FIG. 1 is an exemplary sketch of a mobile housing for charging a mobile device.

FIG. 2 is an exemplary sketch of a mobile housing having a wireless charging interface for charging a mobile device.

FIG. 3 is an exemplary sketch of a mobile housing having energy capture modules for charging a mobile device.

FIGS. 4A and 4B are exemplary sketch views of a mobile housing for charging a mobile device.

FIGS. 5A, 5B and 5C are exemplary sketch views of a mobile housing for charging a mobile device.

### DETAILED DESCRIPTION

This document describes systems and techniques for charging mobile devices. In one exemplary implementation, a mobile housing includes an energy source and a connector. When a mobile device is placed into the mobile housing, the energy source in the mobile housing transmits charge to the mobile device through the connector to charge the energy source within the mobile device. In this manner, the energy source in the mobile housing may include a larger power storage cell than the energy source for the mobile device. The mobile device may use a smaller storage cell and recharge its energy source from the larger energy storage cell contained within the mobile housing. For example, smaller batteries may be used in the mobile device, thus making the mobile device capable of being made smaller since the batteries in the mobile device may be readily recharged from the energy source within the mobile housing. Both the mobile housing and the mobile device may be portable so the mobile device may be charged and/or re-charged without being tethered to a wall outlet by a charging cord.

In one exemplary implementation, the mobile housing may be a mobile sleeve capable of receiving and storing the mobile device. The mobile sleeve may be portable and configured to carry the mobile device. In this manner, the energy source in the mobile device may be charged from the energy source in the mobile sleeve even while the mobile device is being carried or transported around.

In another exemplary implementation, the mobile housing may be a mobile bag (e.g., cloth bag, canvas bag, nylon bag, any other type of bag, etc.) that also may be used to carry the mobile device. For instance, the mobile bag may include one or more straps or one or more handles to carry the bag and the mobile device. In this manner, the mobile device may charge its energy source from the energy source within the bag. In one exemplary implementation, the mobile sleeve may be temporarily or permanently installed in a mobile bag. For example, the mobile sleeve may include an outer surface that includes a grip-type coating (e.g., on at least a part of the outer surface) such that when the mobile sleeve is inserted into a mobile bag and the mobile device is withdrawn from the mobile sleeve, the outer surface of the mobile sleeve will cause the mobile sleeve to remain within the mobile bag when the mobile device is being withdrawn.

In one exemplary implementation, the connector in the mobile housing may mate with a charging port on the mobile device to transfer charge from the energy source within the mobile housing to the energy source of the mobile device. The connector may be configured to mate ohmically (e.g., a metal to metal mating) with a charging port on the mobile device. Also, the connector may include a retractable and/or detachable cord reel to enable the mobile device to be charged and/or operate outside of or external to the mobile housing while tethered to the energy source within the mobile housing. In this manner, the mobile device may be operated at the same time as being re-charged by the energy source within the mobile housing.

In another exemplary implementation, the connector may include a wireless charging interface configured to transfer charge (e.g., inductively or capacitively) from the energy source in the mobile housing to the energy source of the mobile device. In this manner, when the mobile device is placed in the mobile housing, the wireless charging interface may be used to transfer charge from the energy source in the mobile housing to the energy source of the mobile device.

In one exemplary implementation, the energy source in the mobile housing may include one or more batteries (e.g., rechargeable batteries). The energy source in the mobile housing may be recharged by plugging a connector into an external energy source (e.g. a wall outlet or other batteries or other energy source). Also, the mobile housing may include a second connector to connect the energy source within the mobile housing to an external energy source. In other exemplary implementations, the mobile housing may be configured to capture solar and/or kinetic energy to charge the energy source within the mobile housing.

In one exemplary implementation, the energy source in the mobile housing may be smaller than the energy source in the mobile device. Even though the energy source in the mobile housing is smaller than the energy source in the mobile device, the smaller energy source in the mobile housing may be used to transfer charge to the energy source in the mobile device. In this manner, a lighter mobile housing may be realized and yet still be able to re-charge the mobile device.

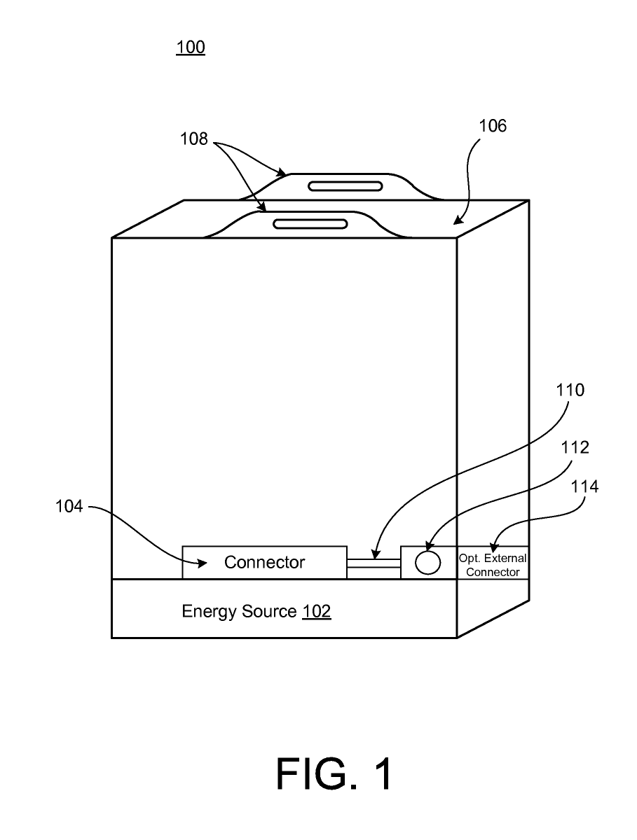

Referring to FIG. 1, an exemplary sketch of a mobile housing 100 for charging a mobile device is illustrated. The mobile housing 100 includes an energy source 102 and a connector 104. The mobile housing 100 is configured to receive a mobile device (not shown) and charge the energy source in the mobile device using the energy source 102 through the connector 104. The mobile housing 100 may receive the mobile device through an opening 106. The opening 106 may include a closure (not shown) to close the opening 106 to hold the mobile device in the mobile housing 100. The mobile device may slide into the opening 106 and be secured within the mobile housing 100. The mobile housing 100 may include other components (not shown) to retain and/or secure the mobile device within the mobile housing 100. For example, the mobile housing may include a guiding means (e.g., rails, wires, guides, tracks, etc.) to assist in guiding and securing the mobile device within the mobile housing 100. Also, the mobile housing may be configured to maintain pressure on the mobile device to keep the mobile device positioned within the mobile housing 100 to assist in maintaining contact with the connector 104. For example, a strap(s) or other similar item may be used to secure and maintain the mobile device in position within the mobile housing 100.

The mobile housing 100 may be configured to receive and charge any particular type of mobile device. For example, the mobile device may include a laptop computer, a tablet computer, a netbook computer, an electronic reading appliance, a mobile phone, a smart phone, a music player, a camera, a video camera, a flashlight, a power tool or any other type of mobile device that includes a rechargeable energy source. The mobile housing 100 may include an adaptor or padding (e.g., flexible padding) to secure and maintain different types of mobile devices within the mobile housing 100.

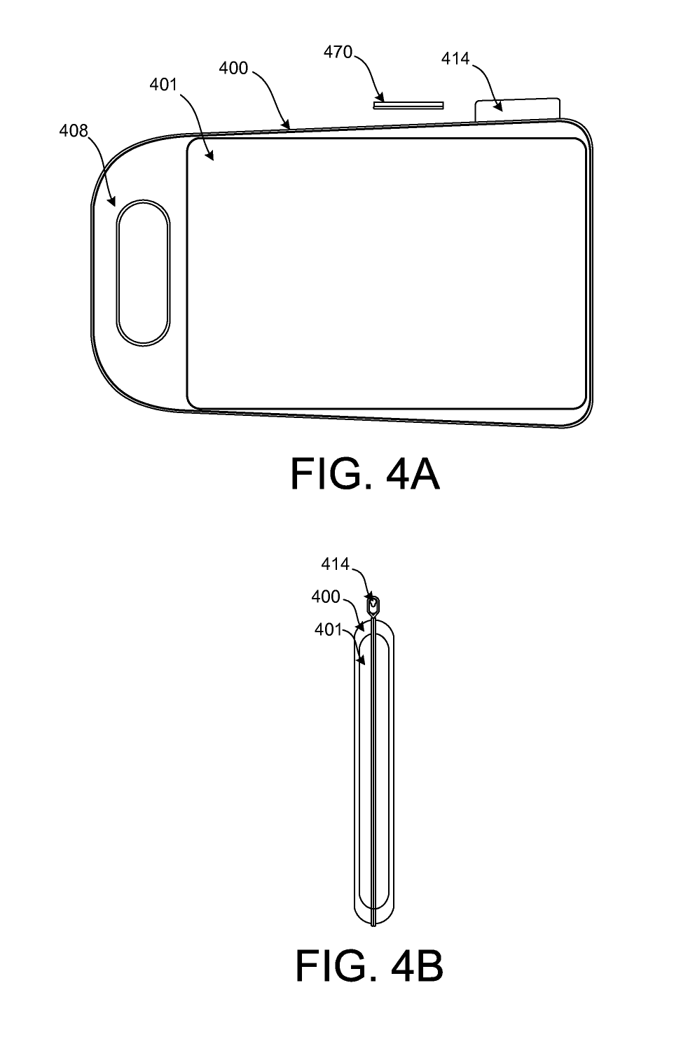

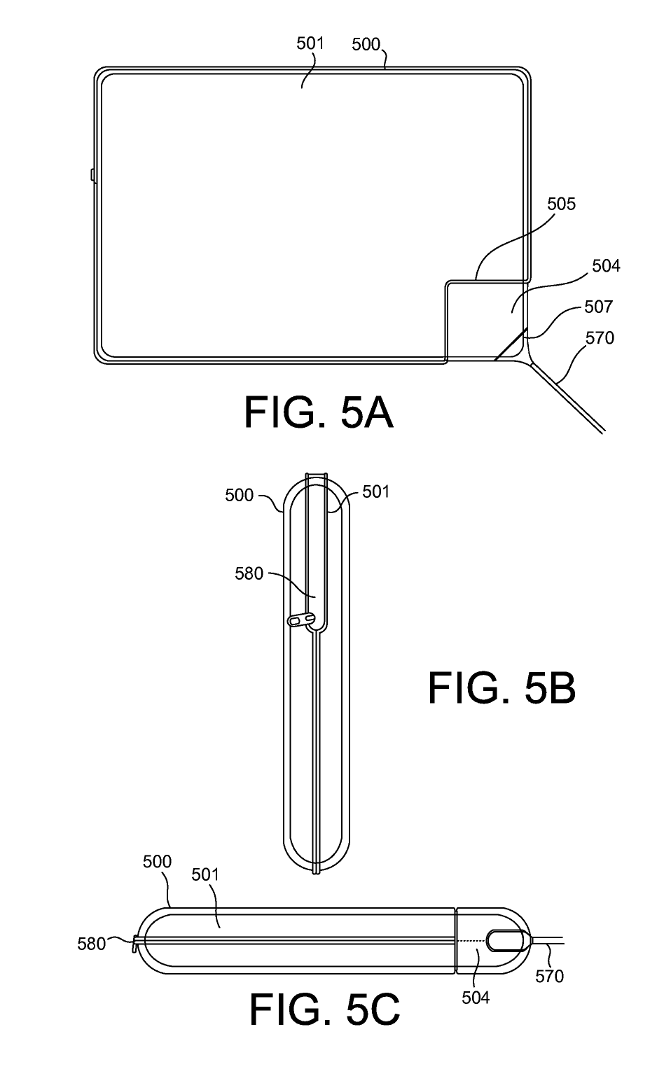

The mobile housing 100 may be configured in any shape or size to receive one or more mobile devices. The mobile housing 100 may be used as a carrying case for the mobile device. In this manner, the mobile housing 100 may be used to charge the mobile device while the mobile device is being carried or transported. The mobile housing 100 may be implemented as a mobile sleeve, a mobile bag, a carrying case, a sling bag or any other type of portable carrying-type case. Other exemplary implementations of different types of mobile housing are illustrated below in FIGS. 4A-5C.

The mobile housing 100 may include one or more handles 108 to carry the mobile housing 100 and any contained mobile device. While handles 108 are illustrated, the mobile housing 100 may include other types of carrying implements such as, for example, one or more straps, a sling strap, a shoulder strap, a belt or other types of means to carry the mobile housing 100 or means to fasten the mobile housing into a larger convenient container.

The energy source 102 may be configured to store energy (a charge) and to transfer the charge to the mobile device through the connector 104. The energy source 102 may include one or more rechargeable batteries such as, for example, rechargeable lithium ion batteries. In this manner, the energy source 102 may provide a charge to the energy source in the mobile device and then be recharged itself through a wall outlet or other means when the charge in the energy source 102 has been depleted.

In other exemplary implementations, the energy source 102 may include one or more fuel cells or other type of power cells that are capable of storing energy. The energy may be transferred from the fuel or power cells to an energy source in the mobile device. Other types of energy sources are also possible including, for instance, a super capacitor and a micro-generator.

The connector 104 may be configured to mate with a charging port on a mobile device that is received into the mobile housing 100. The connector 104 mates with the mobile device and is used to transfer a charge from the energy source 102 to an energy source in the mobile device. The connector 104 may be configured to mate with different types and/or styles of charging ports on mobile devices. The connector 104 may be configurable to mate with different types of charging ports and/or may include one or more adaptors to enable the connector 104 to mate with different types of connections on the mobile device.

In one exemplary implementation, the connector 104 includes a cord 110 and a cord reel 112, where the cord 110 and the cord reel 112 are operably connected to the energy source 102 and the cord 110 is connected to the connector 104. For example, the connector 104 may not be fixed to the energy source 102, but may be unfixed and not attached to the power 102. The connector 104 may be detachable from the energy source 102. The cord 110 and the cord reel 112 may include a length of cord that enables the connector 104 to extend beyond and outside of the mobile housing 100. In this manner, the mobile device may be used outside of the mobile housing 100 and charged by the energy source 102 in a tethered manner using the connector 104, the cord 110 and the cord reel 112 at the same time.

In one implementation, the cord reel 112 may be a retractable cord reel. For instance, the retractable cord reel may be a spring-loaded wheel-type mechanism that allows the cord 110 unwind and to be extended from around the wheel mechanism and optionally lock the wheel mechanism. Then, a slight pull or tug on the cord 110 may release the lock and cause the wheel mechanism to re-wind the cord 110 around the cord reel 112.

In one exemplary implementation, the cord reel 112 may be detachable. The cord reel 112 may detach from the mobile housing 100 such that the cord reel 112 is removable from the mobile housing 100. The cord reel 112 may include a plug that allows it to connect to a wall outlet or other AC and/or DC outlet to recharge the energy source 102. In this manner, the cord reel 112 may be detached from the mobile housing 100 and connected to an external energy source to charge the energy source 102.

In one exemplary implementation, the mobile housing 100 may optionally include a second connector 114. The second connector 114 may be configured on the outer or external side of the mobile housing 100. The second connector 114 may be operably connected to the energy source 102, the connector 104, the cord 110 and/or the cord reel 114. In one exemplary implementation, the second connector 114 may be a female-type connector configured to receive a cord to connect to an external energy source to charge the energy source 102 through the second connector 114. In another implementation, the second connector 114 may be a male-type connector configured to receive a cord to connect to an external energy source to charge the energy source 102 through the second connector 114. In other implementations, the second connector 114 may include prongs or other plug-type features that enable the second connector 114 to be connected directly to an external energy source to charge the energy source 102 through the second connector 114.

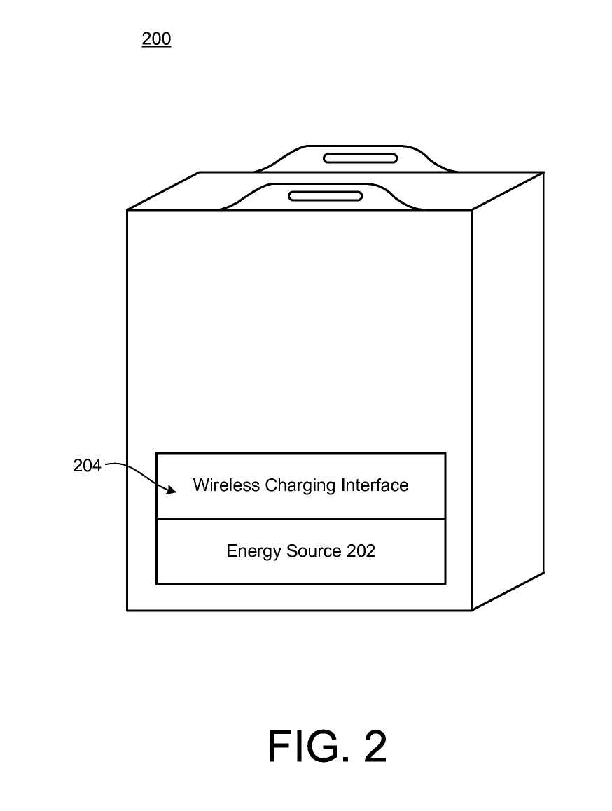

Referring to FIG. 2, an exemplary sketch of an exemplary mobile housing 200 for charging a mobile device is illustrated. The mobile housing 200 may include all of the same or similar features described above with respect to mobile housing 100 of FIG. 1, as discussed above. In this exemplary implementation, the mobile housing 200 includes an energy source 202 and a wireless charging interface 204. The energy source 202 may include all of the same or similar features as the energy source 102 of FIG. 1.

The wireless charging interface 204 may be used instead of the connector 104 of FIG. 1 to connect to a mobile device (not shown). The wireless charging interface 204 may connect to a charging interface on the mobile device to charge an energy source in the mobile device from the energy source 202 through the wireless charging interface 204. In this manner, any time a user places a mobile device in the mobile housing 200, the energy source in the mobile device may be charged from the energy source 202 through the wireless charging interface 204. The wireless charging interface 204 is configured to transmit charge to the energy source in the mobile device through an interface on the mobile device.

In one implementation, the wireless charging interface 204 may include a charging coil or plate that mates with a charging coil, plate or other receiving connector on the mobile device. The charging coil may be used to transfer charge from the energy source 202 to an energy source in the mobile device through the charging coil or plate and a charging coil, plate or other receiving connector on the mobile device.

The mobile housing 200 may include other features such as, for example, an adaptor, padding (e.g., flexible padding), straps or other implements that may be used to secure the mobile device within the mobile housing 200 to help the mobile device to stay and maintain position within the mobile housing 200 to assist in the transfer of charge through the wireless charging interface 204.

In one exemplary implementation, the mobile housing 200 may include a connector (e.g., connector 104 of FIG. 1) (not shown in FIG. 2) in addition to the wireless charging interface. The mobile housing also may include a cord, a cord reel and a second connector (e.g., cord 110, cord reel 112 and second connector 114 of FIG. 1) (not shown in FIG. 2). In this manner, the mobile housing 200 may be configured to charge an energy source in a mobile device from the energy source 202 through either the wireless charging interface 204 or a connector.

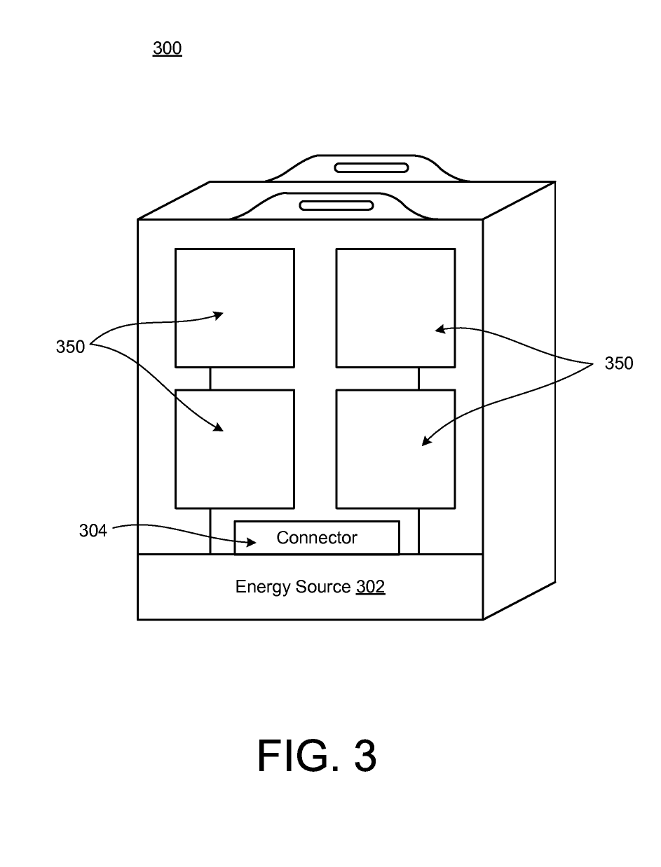

Referring to FIG. 3, an exemplary sketch of an exemplary mobile housing 300 for charging a mobile device is illustrated. The mobile housing 300 may include all of the same or similar features described above with respect to mobile housing 100 of FIG. 1, as discussed above. In this exemplary implementation, the mobile housing 300 includes an energy source 302, a connector 304 and one or more energy capture modules 350. The energy source 302 may include all of the same or similar features as the energy source 102 of FIG. 1 and the connector 304 may include all of the same or similar features as the connector 104 of FIG. 1. The mobile housing 300 also may include the other components and features of the mobile housing 100 of FIG. 1, even though not illustrated in FIG. 3.

The mobile housing 300 may use one or more energy capture modules 350 to capture energy that is then transferred to and stored in the energy source 302. The energy capture modules 350 may be connected to each other and each of the modules 350 may be connected to the energy source 302. For instance, in one implementation, the energy capture modules 350 may include one or more solar panels having solar cells configured to capture solar energy for storage in the energy source 302. The stored solar energy may be used to charge an energy source in a mobile device through the connector 304. If needed, the solar energy may be temporarily stored and/or converted by the energy capture modules 350 before being transferred to the energy source 302 for longer term storage. In this manner, when the mobile housing 300 is exposed to the sun, the solar panels capture the solar energy and store the solar energy (or converted solar energy) in the energy source 302 for later use to charge an energy source in a mobile device.

In another exemplary implementation, the energy capture modules 350 may include one or more kinetic energy capture modules. The kinetic energy capture modules may be used to capture kinetic energy, for example, through the movement of the mobile housing 300 as it is being carried, either with or without a mobile device in the mobile housing 300. The captured kinetic energy may be converted and stored in the energy source 302 for later use to charge an energy source in a mobile device.

In another exemplary implementation, the energy capture modules 350 may include one or more special fabrics that are capable of storing a charge. The charge stored in the special fabrics may be used to charge and energy source in a mobile device.

Referring to FIGS. 4A and 4B, an exemplary mobile housing 400 for charging a mobile device 401 is illustrated. The mobile housing 400 may include the same or similar features as the mobile housing 100 of FIG. 1, as described above. For example, the mobile housing 400 may be a mobile sleeve, a mobile case (e.g., soft case, hard case, etc.), bag (e.g., cloth bag, nylon bag, synthetic bag, etc.) or other type of carrying case or other mounting bracket or mounting means (e.g., double stick tape, magnet, etc.). The mobile housing 400 may be configured to receive a mobile device 401. The mobile device 401 may be any type of mobile device, as described above. The mobile housing 400 includes an energy source (not shown) and a connector (not shown) (e.g. connector 104 of FIG. 1) and/or a wireless charging interface (not shown (e.g., wireless charging interface 204 of FIG. 2)). The mobile housing may include a handle 408 to carry both the mobile housing 400 and the mobile device 401.

When the mobile device 401 is inserted into the mobile housing 400, a receiving connector on the mobile device 401 may mate with the connector in the mobile housing 400 to transfer charge from the energy source in the mobile housing 400 to an energy source in the mobile device 401. The energy source in the mobile housing 400 may be a higher capacity energy source than the energy source in the mobile device. The mobile housing 400 does not need to be connected to any external energy source in order for the energy source in the mobile housing 400 to transfer charge to the energy source in the mobile device 401.

The mobile housing 400 may include a second connector 414. The second connector 414 may include the same features and the functionality as the second connector 114 of FIG. 1, as described above. In this example, the second connector 414 may be connected to the energy source in the mobile housing 400. The second connector 414 may be connected to an external energy source through cord connector 470 to provide a charge to the energy source in the mobile housing 400. If the mobile device 401 is in the mobile housing, the charge from the external source also may charge the energy source in the mobile device 401 at the same time through the second connector 414.

An outside of the mobile housing 400 may optionally include one or more features such as mounting brackets, magnets, or other mounting means to connect the mobile housing 400 to other devices or appliances.

Referring to FIGS. 5A-5C, an exemplary mobile housing 500 for charging a mobile device 501 is illustrated. The mobile housing 500 may include the same or similar features as the mobile housing 100 of FIG. 1, as described above. For example, the mobile housing 500 may be a sleeve, a case (e.g., soft case, hard case, etc.), bag (e.g., cloth bag, nylon bag, synthetic bag, etc.) or other type of carrying case. The mobile housing 500 may be configured to receive a mobile device 501. The mobile device 501 may be any type of mobile device, as describe above. The mobile housing 500 includes an energy source and a connector 504 (e.g. connector 104 of FIG. 1) and/or a wireless charging interface (not shown (e.g., wireless charging interface 204 of FIG. 2). The mobile housing may include a zipper closer 580 to close the mobile housing 500 around the mobile device 501.

In this example, the connector 504 may include multiple different features. For example, the connector 504 may include both an internal connection interface 505 to connect to a receiving connector on the mobile device 501 and an external connection interface 507 to connect to a cord connector 570, which may connect to an external energy source. The connector 504 may be located in a corner of the mobile housing 500. The connector 504 also may house the energy source for the mobile housing 500. In this manner, when the mobile device 501 is inserted into the mobile housing 500 and is mated with the connector 504, the energy source in the mobile device 501 may be charged from the energy source contained in the connector 504. In other implementations, the energy source for the mobile housing 500 may be located elsewhere within the mobile housing 500 and operably connected to the connector 504.

Also, the connector 504 may simultaneously be connected to an external energy source through cord connector 570 that mates to the external connection interface 507. In this manner, the mobile housing 500 may charge its energy source and the energy source of the mobile device 501 simultaneously.

A number of embodiments have been described. Nevertheless, it will be understood that various modifications may be made without departing from the spirit and scope of the invention. For example, the mobile housings (e.g., 100 of FIG. 1, 200 of FIG. 2, 300 of FIG. 3, 400 of FIGS. 4A and 4B and 500 of FIGS. 5A-5C) may include other components that were not illustrated in the figures. For instance, the mobile housings may include a controller and/or a processor. The mobile housings also may include a memory device. The memory device may include a non-transitory storage medium configured to store instructions that may be executed by the controller or processor to perform various functions related to the energy source in the mobile housing including charging the energy source and transferring charge from the energy source in the mobile housing to an energy source in the mobile device.

Also, the mobile housing (e.g., 100 of FIG. 1, 200 of FIG. 2, 300 of FIG. 3, 400 of FIGS. 4A and 4B and 500 of FIGS. 5A-5C) may be configurable to adapt to different types of mobile devices. For example, the mobile housing may include an adapter or flexible padding or other type of material to receive different types and sizes of mobile devices and to secure the mobile devices in the mobile housing such that the mobile device is able to make and maintain a good connection with the energy source in the mobile housing through the connector.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

1. A mobile charging apparatus for a mobile device, comprising:
a mobile sleeve capable of receiving and storing a mobile device, the mobile sleeve comprising a first connector to mate with a charging port on the mobile device, wherein the first connector includes a retractable cord reel and cord configured to extend the first connector external to the mobile sleeve and wherein the retractable cord reel and at least a portion of the cord are housed within the mobile sleeve; and
a mobile energy source contained within the mobile sleeve to provide a charge to the mobile device through the first connector.

2. The mobile charging apparatus of claim 1 wherein the energy source comprises one or more batteries.

3. (canceled)

4. (canceled)

5. (canceled)

6. The mobile charging apparatus of claim 1 wherein the first connector is configured to connect to an external energy source to charge the energy source contained within the mobile sleeve.

7. The mobile charging apparatus of claim 1 further comprising a second connector configured to mate with an external energy source to charge the energy source contained within the mobile sleeve.

8. The mobile charging apparatus of claim 1 wherein:
the mobile sleeve comprises a bag capable of receiving and storing the mobile device and the bag comprises the first connector to mate with the charging port on the mobile device; and
the energy source is contained within the bag to provide the charge to the mobile device through the first connector.

9. The mobile charging apparatus of claim 1 wherein the mobile sleeve comprises a device to capture solar energy and the energy source is configured to store the solar energy and to provide the charge to the mobile device through the first connector using the stored solar energy.

10. The mobile charging apparatus of claim 9 wherein the energy source comprises a fuel cell.

11. A mobile charging apparatus, comprising:
a mobile sleeve capable of receiving and storing a mobile device, the mobile sleeve comprising:
an energy source,
a first connector configured to mate with a charging port on the mobile device to charge the mobile device from the energy source, and
a retractable cord reel and cord configured to extend the first connector external to the mobile sleeve, wherein the retractable cord reel and at least a portion of the cord are housed within the mobile sleeve.

12. The mobile charging apparatus of claim 11 wherein the mobile sleeve comprises a bag.

13. The mobile charging apparatus of claim 11 wherein the energy source comprises one or more batteries.

14. The mobile charging apparatus of claim 11 wherein the first connector is configured to connect to an external energy source to charge the energy source in the mobile sleeve.

15. The mobile charging apparatus of claim 11 wherein the mobile sleeve comprises one or more devices to capture solar energy and the energy source is configured to store the solar energy and to provide the charge to the mobile device through the first connector using the stored solar energy.

16. The mobile charging apparatus of claim 11 wherein the mobile sleeve comprises a second connector configured to mate with an external energy source to charge the energy source in the mobile sleeve.

17. The mobile charging apparatus of claim 11 wherein the retractable cord reel and cord are detachable from the mobile sleeve.

18. (canceled)

19. (canceled)

20. (canceled)
